(19) United States
(12) Patent Application Publication
(10) Pub. No.: US 2022/0297353 A1
(43) Pub. Date: Sep. 22, 2022

(54) Method and Installation for the Treatment of Olfactorily Contaminated Plastics

(71) Applicant: Johannes Wissing, Stadtlohn (DE)

(72) Inventors: Johannes Wissing, Stadtlohn (DE); Werner Schemmann, Rietberg (DE)

(21) Appl. No.: 17/837,473

(22) Filed: Jun. 10, 2022

Related U.S. Application Data
(63) Continuation of application No. PCT/EP2020/085856, filed on Dec. 11, 2020.

(30) Foreign Application Priority Data
Dec. 12, 2019 (DE) 102019134203.1

(51) Int. Cl. B29B 17/02; B29B 17/04

(52) U.S. Cl. CPC B29B 17/02; B29B 17/04; B29B 2017/0015

(57) ABSTRACT

A method and a system to increase the material utilization options of plastics with olfactory effective build-ups, such that they do not need to be disposed of, involving a pre-treatment, an oxidizing agent treatment and a conditioning to generate an end substrate that can be used as a raw material for the production of plate-type materials, molded parts, packaging and films within the scope of extrusion or injection molding methods or as an additive for other products.

### BACKGROUND INFORMATION

### Field of the Invention

The invention relates to a method and a system for treating plastic materials that are contaminated with olfactory-active residues that cause an unacceptable odor. More specifically, the method relates to a multi-stage process, in which the plastic materials are treated to remove the contamination, so that they may be subsequently used in the production of other plastic products.

### Discussion of the Prior Art

Organic substances, i.e., animal and/or plant microorganisms, can attach to and grow on plastics of any kind, and this is particularly a problem with plastic food packaging, because these organic substances develop an odor. Much emphasis is placed these days on recycling plastic materials, but the organic residues and the odors limit the recycling options. For this reason, a lot of plastic materials are not recycled, but instead, end up in landfills or are burned in a thermal energy plant, whereby both of these types of disposal create environmental burdens. A better option for the environment is to be able to use such plastic materials in the production of other plastic products. Before such contaminated plastic materials can be re-used or recycled, however, they must first be cleaned.

Many treatment methods for treating organically-contaminated plastic materials in technical facilities or installations are known. There are, for example, a number of methods that use a liquid-based washing process to make plastic materials acceptable for subsequent use. In the discussion hereinafter of such olfactorily contaminated plastics, the contaminating organic substances are referred to as ‘residues.’

WO 2017/167725 A1 teaches a method in which plastic is introduced into a fluid and the fluid/plastic mixture is set in motion, in order to wash off the residues and fractionate the material. Washing processes are in principle problematic, because they require large quantities of a washing fluid, which then has to be clarified. The resulting residues also then need to be disposed of, and that is cost-intensive. The use of high-temperature washing fluids also requires significant input of energy. Furthermore, such washing methods cannot always eliminate long-lasting odors.

DE 102012024 111 A1 discloses a method for manually treating bio-substrates that are odor-contaminated, such as hydrogen sulfide-forming waste. This method essentially masks odor-causing impurities by adding substances that bind olfactory-active substances. Both the production and the preparation of the additives, however, are cost-intensive. Furthermore, the masked impurities remain in the substrate, so that restrictions may remain with regard to subsequent uses.

JP 2002-292 304 A discloses a sterilization method for cleaning soiled sanitary articles, such as diapers or the like. The soiled sanitary articles are ground up and washed in various water baths that contain a disinfectant. This method is cost- and energy intensive, because the bath water with the solids has to be filtered to remove the solids, and then the wash water has to be treated to remove the contamination.

WO 2014/079469 A1 discloses a method and a device for processing waste water and organic waste. Liquid and solid phases of the waste are separated from one another. The liquid phase is then processed and the solid phase sent on to a biogas plant where it is used to produce biogas. This method does not foresee using the solid phase to manufacture another plastic product.

One problem that is common to all of the known methods is that multi-stage treatment processes are often very cost-intensive and time-intensive. Furthermore, the known methods are associated with high environmental pollution, particularly because it is necessary to process the washing water that is used, and that is costly. It can be problematic, if the olfactory-active compounds are not completely removed, but rather, are merely chemically masked, with the result that the recycling potential of such contaminated plastics remains quite limited. As a result, the recycling options for such plastic materials cannot be fully exhausted and disposing of such materials increases environmental burdens, because the materials either end up in landfills or, when used in thermal recovery operations, release climate-relevant CO2 when the plastic material is incinerated.

What is needed, therefore, is a method of treating olfactorily contaminated plastic materials, such that the materials may be recycled and used in the production of other plastic products. What is further needed is a method that does not result in a break-down of the elasto-mechanical properties of the plastic material. What is yet further needed is a method that is environmentally friendly.

### BRIEF SUMMARY OF THE INVENTION

It is an object of the invention to be able to recycle plastic materials that are contaminated with residues of olfactory-active substances so that such materials are acceptable for recycling uses in the production of other products.

This object is achieved by a multi-stage treatment method that uses an oxidizing agent to modify and/or break down olfactory-active residues that adhere to a plastic substrate, as well as equipment for carrying out the method. The recycling options for plastics treated according to the invention include panel-like products, molded products, packaging material, films, fillers, and additives.

Olfactory-active contamination is defined as contamination that exudes a perceptible odor. The goal of the de-contamination treatment of plastic materials is to modify and/or break down the residues that cause unacceptable odors. Odors are considered to have been modified and/or broken down, if they are no longer perceptible to a substantial number of people in a focus group, each person having an average odor sensitivity, or if the odor intensity is no longer perceived as disturbing. Olfactometry, for example, may be used as a detection method to evaluate the odor.

The method according to the invention is a multi-stage process for treating contaminated plastics with an oxidizing agent to effectively modify and/or break down olfactory-active contamination and thereby eliminate odor-related restrictions on recycling options for the plastics. The method according to the invention does not introduce substances that remain in the treated plastic material, nor does it require the use of large amounts of washing or process water or water baths that include a disinfectant. The method allows the treatment to be adapted to the type and severity of the contamination without excessively degrading certain properties of the plastic material, thereby holding open as many recycling options as possible.

The starting point for the method according to the invention are plastic materials of any kind to which olfactory-active substances or residues adhere, such as, for example, fats, proteins and fungi or fungal spores, and in particular, plastics that were originally used as packaging for foodstuffs.

If the olfactorily contaminated plastics to be treated are large in size, or the range of sizes is broad, then it is advantageous to fragment, i.e., to break or shred, the plastics into smaller pieces, and particularly, into pieces that are relatively uniform in size. The smaller, more uniform size ensures a sufficiently reactive surface for subsequent method steps. The olfactorily contaminated plastics that are undergoing treatment according to the invention are referred to generally as ‘substrate,’ whereby the fragmented olfactorily contaminated plastics that have not yet been subjected to treatment are referred to as ‘raw substrate.’ A maximum edge length of 30 mm is a suitable dimension, and an edge length of 5 to 8 mm most suitable, for the raw substrate.

It may also be advantageous to pre-sort the raw substrate according to fragment size and/or type of olfactory contamination and/or the type of plastic materials. Homogeneity of the plastic materials significantly increases the economic efficiency of the method, because this allows process parameters to be specifically adapted to the limit conditions. In principle, however, the method according to the invention may also be used to treat mixes of different types of plastic material that may also have different olfactory residues.

The raw substrate may be pre-treated to remove coarse contaminants from the substrate and/or to partially break apart, modify and/or decompose olfactory-active substances. The pre-treatment may be a dry-mechanical cleaning, a cold wash, and/or a hot wash. A dry mechanical cleaning has the advantage that it does not use a washing fluid, which would then have to be clarified. Cold-water washing processes and/or hot water washing processes are optional processes that provide a more intensive pre-cleaning of olfactorily contaminated plastics than a dry mechanical cleaning. It may be useful to use a liquid bath or wash to remove odor-causing impurities that will wash off with a liquid. In principle, hot-water washing processes are used only in the case of extremely-contaminated raw substrate, because of the increased energy requirement.

The raw substrate may also be biologically pre-treated in a fermentation process. Fermentation breaks apart, modifies, and/or decomposes the olfactory-active substances and, to a limited extent, the plastic materials, but does not significantly degrade the plastic materials or diminish the elasto-mechanical properties of the materials. This is important in maintaining as many recycling options as possible for the plastic materials. Dry fermentation is a suitable process that results in sufficient biological reactivity, even if the substrate is very dry and/or is extremely contaminated. The combined use of a dry mechanical cleaning and fermentation eliminates the need for resource-intensive washing with washing fluids and, thus, is a very economic use of resources.

Fermentation processes require that the substrate contain a certain amount of moisture. Thus, water is added to the raw substrate prior to fermentation to make a mash. Adding water also allows the mash to be pumped, and this facilitates transporting the substrate through the various processing stations. Also, a subsequent conditioning step produces condensation water as a by-product, and this water may be used to make the mash, thereby minimizing water consumption and eliminating a cost-intensive treatment and/or disposal of the condensation water.

The fermentation process releases energy-rich gases, in particular, methane. These gases may be captured and used for energy recovery, for example, by supplying them to a thermal energy plant. The electrical energy that is generated with these gases may be used to power electrical equipment or be supplied to an external consumer. On the other hand, the thermal energy that is won may be used to optimize the fermentation temperature, or may be used in the conditioning stage of the moist substrate. This significantly increases the efficient use of resources.

The pre-treatment phase ends after fermentation and the treatment phase begins. The raw substrate that has been cleaned, and in this case, fermented, is now referred to as intermediate substrate.

Prior to fermentation, the desired moisture content of the mash is between 5 and 15%, and preferably between 8 and 12%. The intermediate substrate has a moisture content between 15 and 30%, and preferably between 15 and 20%. The moisture content is important for the subsequent method steps, because it influences the reactivity for chemical processes and flow properties. The flow properties are of particular importance for the design of the equipment. On the one hand, substrate with lower viscosity is more easily transported because it can be pumped. On the other hand, when defining the desirable viscosity, the substrate has to have a viscosity that ensures that it reliably remains on the carrier as it is carried through the treatment process.

The intermediate substrate is then treated with an oxidizing agent. A reaction holding time begins as soon as the oxidizing agent is added to the substrate. As soon as the oxidizing agent is added, the substrate is now referred to as a ‘moist substrate.’ The duration of the reaction holding time is determined by the amount of time that is required to modify and/or break down the olfactory-active residues completely or to an acceptable level, i.e., the contamination has been sufficiently removed to keep a wide spectrum of recycling options open.

Preferably, the oxidizing agent is applied in liquid form, although alternative forms, such as powders, may also be suitable. Adding the oxidizing agent to the substrate immediately starts a process of modifying and/or breaking down the contaminants, and particularly the organic substances, such as fats, proteins, fungi, and fungal spores. The method according to the invention does not suggest adding further substances, particularly substances that react as a function of the oxidizing agent, whereby the content and distribution of moisture of the intermediate substrate can directly influence the action of the oxidizing agent.

In the method according to the invention, hydrogen peroxide is used as an oxidizing agent. In contrast to alternative oxidizing agents, hydrogen peroxide may be produced in a cost-effective manner on an industrial scale and its process engineering use can be implemented economically. It is not necessary to implement special safety measures to ensure occupational safety and corrosion protection, as is the case when using alternative oxidizing agents, for example, ozone. Furthermore, environmental hazards are low, since pure hydrogen peroxide decomposes into water and oxygen, without the formation of burdensome by-products, yet has sufficient chemical stability for technical use.

Hydrogen peroxide has a cytotoxic effect and is a suitable oxidizing agent to modify and/or break down fats, proteins, fungi or fungal spores and other organic molecular groups. The modification and/or break-down of molecules is induced by free radicals. Highly volatile substances are removed from the treatment process and can be used, for example, in a thermal recovery operation. Less volatile and non-volatile fragments remain in the treated moist substrate, but without causing further odor pollution to develop. Some of these fragments can aggregate with mineral components, which may be present, for example, as contaminants in the olfactorily contaminated plastic materials. Sensors may be used to detect volatile decomposition products. This detection may usefully serve to monitor the progress of the treatment, for example, the data may be used to provide information about the intensity of the decomposition or the progress of a treatment process.

For reasons of economy and ease in handling, the concentration of the hydrogen peroxide is between 9 and 60%, preferably between 35 and 45%, and most preferably 40%. In principle, the concentration of the hydrogen peroxide is adapted to the type of the plastic materials and the olfactory-active compounds. For reasons of efficiency, an amount of hydrogen peroxide approaching a maximum value may be used. If too much hydrogen peroxide is added, it is not completely consumed and/or it diminishes the elasto-mechanical properties of the moist substrate to an unacceptable extent. The reaction is primarily terminated by adding water. If too little is added, the olfactory-active compounds are not sufficiently modified and/or degraded, and, as a result, the substrate still carries an odor.

The reaction holding time, during which the moist substrate reacts with the oxidizing agent, begins as soon as the oxidizing agent is added. The process parameters and the physical-chemical characteristics of the final substrate are decisively influenced by the chemical processes during the reaction holding time. Exothermic reactions occur, causing the process temperature to increase during the reaction holding time, preferably to 60 to 80° C., without the need for an external energy supply. Elevated process temperatures degrade thermo-sensitive components of the moist substrate. A further advantage of the elevated process temperatures is that it raises the temperature of the liquid in the moist substrate and this reduces the amount of input energy required in the subsequent conditioning phase.

Determining the optimal reaction holding time results in the most efficient process control possible of the method according to the invention. Thus, process technology is used to adapt the amount and the concentration of the oxidizing agent to the type, quantity and distribution of the olfactory-active compounds.

Ideally, the concentration and the amount of the oxidizing agent and its effect in the process is monitored by an automated monitoring system, in particular with regard to the break-down or decomposition of organic components. Suitable monitoring means include, for example, analyzing the gas composition directly above the moist substrate, optically detecting the color of the moist substrate, or recording the process temperature. If the detected actual values of the gas composition deviate from a specified value, the concentration and/or the amount of the oxidizing agent may be adjusted, in order to ensure that the olfactory-active compounds are sufficiently degraded by the end of the reaction holding time and thus avoiding any odor-related restrictions on a subsequent recycling use of the substrate.

The process parameters may be adjusted to achieve an effective reaction time holding time of 20 to 40 minutes, and more preferably, 30 to 35 minutes, so that, at the end of this reaction holding time, the olfactory-active compounds have been modified and/or broken down to such an extent that the contamination is deemed non-existent, yet the elasto-mechanical properties of the moist substrate have not been degraded to the extent that they fall below strength requirements that are specified by the subsequent intended use for the final substrate.

In one embodiment, the moist substrate may be exposed during the reaction holding time to ultraviolet radiation. This increases process efficiency, because, on the one hand, it intensifies the formation of free radicals, thereby increasing the effectiveness of the oxidizing agent, and at the same time directly splits apart olfactory-active compounds. The ultraviolet radiation in combination with adjusting the appropriate concentration and quantity of the oxidizing agent are control variables that have a significant influence on the duration of the reaction holding time and on the progression of the treatment during the reaction holding time.

A sensor system may be used to monitor the reaction holding time. The sensors detect the break-down of the organic substances and that data provides information on how far the treatment has progressed. Should a process parameter deviate from a previously defined setpoint, the concentration or the amount of the oxidizing agent and/or the intensity of the ultraviolet radiation may be adjusted without having to interrupt the ongoing process. There are a plurality of detection methods for this purpose that a person skilled in the art will know how to use. Examples of suitable sensors include: color sensors, gas sensors, temperature sensors, and moisture sensors.

A color sensor that automatically detects the appearance of the substrate may be used to optically monitor the condition of the substrate. If the color sensor optically detects an appearance that deviates from a predefined specified value, such as, for example, the appearance of a bleached moist substrate, the sensor triggers an appropriate adjustment of the quantity or concentration of the oxidizing agent and/or the intensity of the ultraviolet radiation. Gas sensors placed directly above the moist substrate may be used to detect defined volatile organic compounds (VOC) and, when the concentration of a gas or substance falls below a specified concentration, initiate an increase in the treatment intensity.

Temperature sensors may be used to detect the temperature of the ambient air of the process and/or the temperature of the moist substrate itself. Exothermic reactions during the treatment are determinative and this makes it possible to draw conclusions about the process from the temperature data and to regulate the process parameters based on those conclusions.

Moisture content has a direct effect on the chemical reactivity, thus, monitoring and regulating the substrate moisture optimizes the efficiency of the treatment. To this end, moisture sensors are provided that detect the moisture content of the moist substrate and trigger an additional moistening of the moist substrate as needed via an application unit.

When the reaction holding time has ended, a subsequent step according to the invention involves conditioning the moist substrate to achieve a desired moisture content. At this step, the substrate is referred to as a ‘dry substrate.’ The desired moisture content of the dry substrate depends on its intended use later on and is achieved by drying and/or adding additional water or water vapor as needed. Most subsequent uses typically require a relatively low target moisture, between 0 and 5%, and preferably between 2 and 3%. A reduced moisture content of the dry substrate also reduces the chances of the substrate particles clumping together or aggregating. Suitable methods of drying the substrate include raising the temperature or blowing in air.

Depending on the specific technology at the treatment facility, the method according to the invention may be implemented as a continuous or discontinuous process.

A treatment system according to the invention includes equipment or a system for treating the olfactorily contaminated plastic materials without introducing substances that remain in the treated plastic. One embodiment of the treatment system comprises at least one treatment container or tank, in which the fragmented raw substrate is pretreated with one or more of the cleaning processes described above, to produce the intermediate substrate. The treatment container is constructed of material that is resistant both to mechanical stress and to the effects of chemical compounds.

The system also includes a treatment carrier that serves to carry the intermediate substrate. The support surface on which the intermediate substrate and then the moist substrate rests is referred to as the substrate-bearing surface. An application unit is used to apply the oxidizing agent to the moist substrate. Ideally, the application unit allows the oxidizing agent to be precisely metered and applied evenly over the substrate. Preferably, the oxidizing agent is applied in liquid form, although alternative forms, such as powders, may also be suitable. It is important that the oxidizing agent be applied evenly to the moist substrate to maintain consistent strength properties on the substrate. Both the treatment carrier and application unit for the oxidizing agent are constructed to achieve the desired homogeneous distribution of the oxidizing agent.

The system according to the invention also has a conditioning unit that produces a target moisture on the dry substrate. For example, to reduce moisture on the substrate, a heater may be provided to raise the air temperature in the conditioning unit. The process temperature in the conditioning unit is preferably between 95 and 175° C. These temperatures also contribute to modifying and/or breaking down thermally sensitive organic components. Nozzles or a misting unit may be provided to introduce water or water vapor into the conditioning unit, either to increase the substrate moisture or to rapidly reduce process temperatures. The conditioning unit lends greater flexibility to the system according to the invention, because it enables a dry substrate to be produced with a moisture content that is required for an intended subsequent use of the substrate.

The system according to the invention may also include a device for pre-sorting the olfactorily contaminated plastic material, Pre-sorting the materials to be processed increases the efficiency of the treatment process, because then the process parameters may be adjusted to the particular material. This does not mean, however, that the system according to the invention is limited to processing batches of plastic material of a specific material. Rather, the system effectively treats batches that are made up of different plastics that may also have different olfactory-active residues.

As mentioned above, the olfactorily contaminated plastic material is subjected to a mechanical comminution or fragmenting prior to the pre-treatment, in order to obtain substrate that has a mostly homogenous geometry and more suitable dimensions for the treatment process. The comminution device may be arranged on the input side, so it feeds the comminuted or fragmented plastic material into the treatment system as the raw substrate. For larger plastic parts, the comminuting device may be constructed as a hammer mill; for plastic films, the device may be a drum carding machine. The pieces of raw substrate thus obtained have a fairly uniform geometry and this facilitates mixing the substrate with water to make a mash for the fermentation process and also prevents an uneven application of the oxidizing agent to the substrate, which can happen, for example, when larger pieces cover up smaller pieces.

The system may include a treatment container or tank with a screening device. For example, the container may be constructed as a screen rotor that is used to pre-treat the raw substrate with a dry mechanical cleaning process. Screen rotors are effective in separating out coarse contaminants, based on mass. This type of cleaning does not require additives, which would have to be processed or disposed of. Depending on the degree of contamination of the plastic material, the mesh size of the screens used has an influence on the intensity of the pre-treatment.

The treatment container may be configured as a washing device with supply lines for cold and/or hot washing fluids. For example, cold water may be used for a cold wash in the washing device to pre-clean the olfactorily contaminated plastic material. This cold wash removes readily soluble adhesions, which are then carried away with the cold wash water. Hot water may be used for a more intensive pre-cleaning, so that even hard-to-dissolve residues, for example, fats, maybe be mobilized and removed.

It may be particularly advantageous to construct the treatment container as a bio-reactor that allows the temperature of the substrate to be fermented or the mash to be regulated. Pipe lines and pump systems with the corresponding controls may be required to regulate the gas balance within the bio-reactor. If the raw substrate is made into a mash, agitators may be used to mix the mash. It may be particularly advantageous to construct the bioreactor as a plug flow reactor, so that, within the framework of an anaerobic, microbial method, difficult-to-split apart and relatively dry substrates, as in the present case, are fermentable in a continuous process. In addition, it may be advantageous to make the mash directly in the reactor or in a section of the reactor. It is, however, possible to use a separate container to prepare the mash.

In order to increase the efficiency of the treatment method, the system may include at least one mixing element which is provided to stir or mix the moist substrate that is placed on the treatment carrier. The aim is to increase the treatment intensity by maximizing the area of contact between the moist substrate and the oxidizing agent. Suitable mixing elements are mixing blades that are integrated into the treatment carrier and/or are also arranged separately from the treatment carrier.

An application device that includes one or more spray heads may be used to apply a solid oxidizing agent onto the intermediate substrate. The spray heads are arranged so as to apply the oxidizing agent over the entire surface of the treatment carrier, thereby ensuring that the oxidizing agent is effectively and evenly distributed over the entire surface that carries the substrate. The application device may include a metering unit to precisely meter the amount of oxidizing agent and precisely apply it, thereby increasing the cost-effectiveness of the treatment. Using spray jets with an optimized jet geometry also ensures a precise application of the oxidizing agent with high spatial resolution that allows the oxidizing agent to be applied sparsely, yet in the amount that is required to achieve the desired outcome. Alternatively, the oxidizing agent may be applied to the substrate via pouring, vapor deposition, or cold nebulization.

Ultraviolet radiation emitters may be arranged such, that the emitters irradiate the moist substrate across substantially the entire surface of the substrate that is on the treatment carrier during the reaction holding time. It is also possible that the emitters irradiate only portions of the carrier surface, for cost-saving reasons. Also, the individual emitters may be separately controllable, thereby enabling a targeted treatment of those areas of the moist substrate that deviate from a previously defined pattern of treatment.

The concentration or amount of the oxidizing agent and/or the intensity of the ultraviolet radiation are process parameters that define the reaction holding time and are to be appropriately adapted to the composition of the substrate. Deviations in certain areas of the moist substrate may occur because of fluctuations in the process temperature, substrate moisture, substrate coloration, and/or concentration of a gas or a substance. Ideally, the spray heads of the application unit and/or the emitters of the ultraviolet radiation are individually controllable, to allow a high spatial resolution treatment of certain areas of the moist substrate, if the sensor system should detect an actual value that deviates from the previously specified value.

A suitable treatment carrier is a conveyor that is driven at a speed that accommodates the reaction holding time, for example, at a feed rate of less than 1 m/minute. The conveyor must, of course, be constructed of material that is resistant to the oxidizing agents, ultraviolet radiation, and/or organic acids. A substrate output device may be used to deposit the intermediate substrate on the conveyor, whereby this substrate may be placed essentially anywhere across the width of the conveyor.

A very thick layer of intermediate substrate may hinder efficient treatment of the substrate. For that reason, it is advantageous that the output device be constructed as a layer-thickness control device that deposits a desired thickness of the substrate onto the conveyor. A suitable layer thickness is up to 100 mm, and more preferably 50 mm. Optimal adjustment of the dry matter ensures that the intermediate substrate or the moist substrate remains on the conveyor. The layer thickness control device may have a metering unit that includes a sensor device, for example, a scale, that ensures that only a defined quantity of the intermediate substrate is placed on the treatment carrier. The layer thickness control device may have a discharge port that produces the desired layer thickness by means of a mechanical scraper.

The treatment carrier may be constructed as a mixing container, for example as a drum mixer. At least one mixing element is arranged in the mixing container, for example, a mixing blade. The oxidizing agent is applied to the substrate in the container by means of one or more application units. Stirring the moist substrate improves the distribution of the oxidizing agent on the surface of the substrate, thereby increasing the efficiency of the method. It is possible for moist substrate to slip off a treatment carrier that is constructed as a conveyor, in particular when the moisture content of the moist substrate is sub-optimally adjusted. But stirring the moist substrate in a mixing container, instead of on a conveyor, prevents any loss of substrate. The ultraviolet radiation emitters may also be provided in such a way that the moist substrate is irradiated in the mixing container.

The conditioning unit may be constructed as a dryer, for example, as a condensation dryer or an infrared dryer, with the treatment carrier, the application unit, and/or the ultraviolet radiation emitters of ultraviolet radiation provided inside the dryer. The conditioning unit is ideally constructed as a compact, closable construction. Simple sensors are provided to detect the process conditions, such as the air temperature or gas composition in the process atmosphere. Monitoring these process conditions also allows the process parameters, for example, the quantity and/or the concentration of the oxidizing agent and/or the intensity of the ultraviolet radiation, to be regulated according to specific requirements. The closed construction eliminates the need for extra process and work safety measures and also significantly reduces energy consumption, because it minimizes energy losses due to heat dissipation. Stirring the moist substrate or dry substrate in the mixing container also aids in mechanically cleaning the substrate and preventing an agglomeration of plastic fragments. In order to minimize space requirements and, thus, investment costs, the system has a compact construction.

Water is released in the drying process and this process water may be used to make a mash of the olfactorily contaminated plastic material. This also eliminates extensive, cost-intensive efforts to dispose or or process the process water.

The system according to the invention may include a sorting device that is arranged downstream of the conditioning unit and that discharges the final substrate. Screens and air separators may be used to remove mineral components and/or organic residues, to ensure a final substrate with a high degree of purity. This sorting may also sort the particles according to size, which may be desirable, depending on the intended subsequent use of the final substrate.

It is a goal of the method according to the invention that the properties of the plastic materials are not significantly degraded as a result of the treatment, because this would restrict the use of the final substrate in plastic products that use recycled plastic material. In particular, in order to produce a final substrate that has properties that make it economically useful to use as a raw material in a subsequent product that uses recycled material, it is necessary to monitor the oxidizing agent that is used and/or monitor a degradation of the material and/or to regulate the relevant process parameters, dependent upon the intended subsequent use.

The final substrate prepared from the olfactorily contaminated plastic material according to the method and system described herein may be used both in extrusion and injection molding processes. The final substrate may be used in the manufacture of homogeneous, panel-like products or heterogeneous composite material. Such materials are usable inter alia in constructing furniture or pallets. With regard to panel-like materials, the final substrate may be used in the production of molded parts. Three-dimensionally molded parts or products produced directly in the injection molding process may be used, inter alia, in furniture construction or in the automotive industry as cladding or, depending on the formulation of the material composition, as a structural component.

The final substrate is also suitable for use as packaging material, i.e., as an outer protective sheath or layer, or as a filler and shock-absorbing material. The final substrate may also be used in producing films. It should be noted here that particularly high requirements are placed on the purity of the final substrate.

The method and system according to the invention produce a final substrate that may also be used as an additive for further mixtures of materials. For example, the final substrate may serve as a filler material, thereby lowering the production costs for subsequent products.

### BRIEF DESCRIPTION OF THE DRAWINGS

The present invention is described with reference to the accompanying drawing.

FIG. 1 is a flow chart that illustrates the method according to the invention of treating olfactorily contaminated plastic materials.

### DETAILED DESCRIPTION OF THE INVENTION

The present invention will now be described more fully in detail with reference to the accompanying drawing. This invention should not, however, be construed as limited to the embodiments set forth herein; rather, the drawing is provided so that this disclosure will be complete and will fully convey the scope of the invention to those skilled in the art.

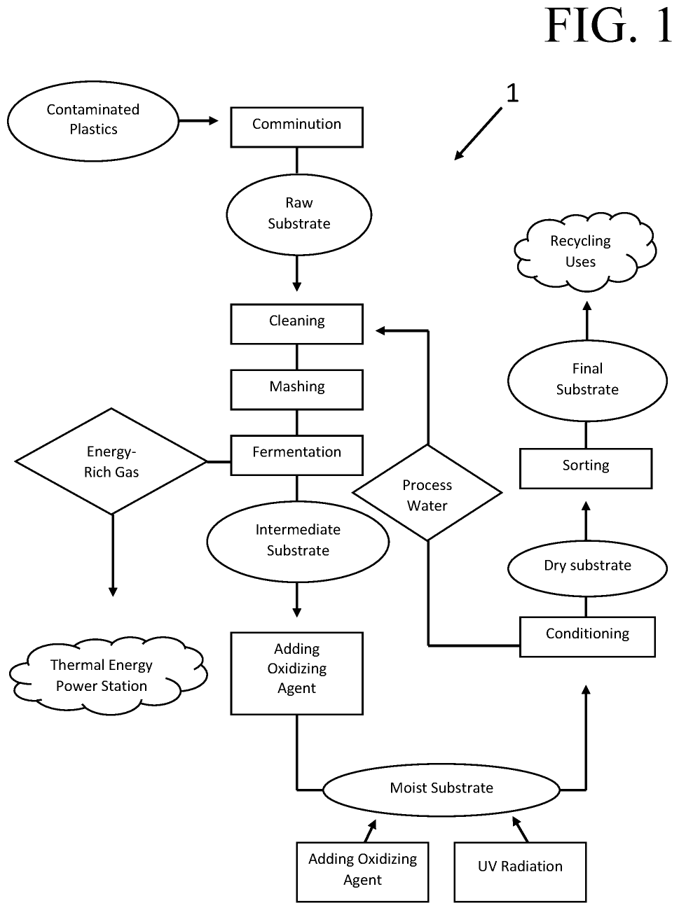

FIG. 1 illustrates the steps of a multi-stage process 1 for the treatment of olfactorily contaminated plastic materials 10, referred to hereinafter simply as the plastic materials 10. In general, organic residues such as fats, proteins, and fungi or fungal spores, can adhere to plastic materials of any kind, and this is particularly the case with plastic packaging of foodstuffs. These residues eventually cause unpleasant odors and make these materials unacceptable for use in other products that use recycled plastic materials. The removal of organic residues is therefore required before a subsequent use.

The method 1 shown in FIG. 1 is a multi-step process that produces a final substrate 17 from the plastic materials 10 that have been cleaned to the extent that they are now suitable for many different uses 18 in subsequently manufactured products. The process parameters of method 1 are adaptable to the type of plastics in the plastic materials 10 and to the olfactory-active residues that adhere to those plastic materials 10. Pre-sorting is not a required step of method 1, but does significantly increase the economic efficiency of the method 1.

Referring now to FIG. 1, the first step is comminuting or fragmenting the plastic materials 10, to obtain a so-called ‘raw substrate’ made up of pieces of solid material that are relatively uniform in size, which increases the effectiveness and the process reliability of the subsequent method steps. The equipment for comminution depends on the type of the plastic materials 10. For example, larger pieces of plastics are reduced in size in a hammer mill, whereas plastic film is shredded in a carding drum.

The comminution 2 is followed by a cleaning step 3. For this purpose, the raw substrate 11 is subjected to a dry-mechanical cleaning 3. Coarse contaminants are released from the raw substrate 11, for example via a screen rotor, without the use of a cleaning fluid. The raw substrate 11 is then subjected to fermentation in step 5. For this purpose, the coarsely cleaned raw substrate 11 is filled into a treatment tank and mixed with water to make a mash 4. In the mashing step 4, the moisture content of the raw substrate 11 is increased to between 8 and 12%. The mashing step 4 improves the accessibility of the olfactory-active residues, as well as the raw substrate 11 during the fermentation process 5. Also, raising the water content allows the raw substrate 11 to be transported more easily to different processing stations, because the mash can be pumped. Process water 20 that is won as a by-product in a subsequent processing step may be used to make the mash 4.

The fermentation process is a dry fermentation. The raw substrate 11 is pumped into a bioreactor that is constructed as a plug flow fermenter and fermented. At this stage, the substrate is now referred to as an ‘intermediate substrate’ 14. Dry fermentation in a plug flow fermenter is a particularly suitable process for partially breaking down the residues, because the dryness of hydrophobic plastic materials, as well as the presence of extremely burdensome substances, does not significantly reduce the efficiency of the method 1. In addition, the decomposition of anaerobic microbials may be integrated as a continuous process into the method 1. The raw substrate 11 may contain mineral components and/or organic acids and for this reason, the plug flow fermenter is constructed of wear-resistant and corrosion-resistant materials. After fermentation 5, the intermediate substrate 14 has a moisture content of between 15 and 20%.

FIG. 1 illustrates that an energy-containing gas 19, for example, methane, that is released during fermentation 5 is captured and supplied to a thermal recovery plant 21 to produce electrical and/or thermal energy. Electrical energy produced by a generator is used for the power the equipment for implementing the method 1. The heat energy released during the combustion of the energy-containing gas 19 is fed to the plug flow fermenter and used to maintain constant optimal fermentation temperatures. Any excess thermal energy is used in a subsequent conditioning step 8.

The combined pre-treatment steps of the dry mechanical cleaning 3 and the fermentation 5 are particularly useful in making the method 1 as efficient as possible. Coarse contaminants that could adversely affect the efficiency of the treatment steps 6 and 7 are removed and the olfactory-active residues are made more susceptible to the subsequent treatment steps 6 and 7. Depending on the type of contamination, the fermentation 5 may also partially break-down or modify the olfactory-active residues. The use of by-products won in the course of method 1, i.e., using captured heat for thermal energy recovery 21 and re-using the process water 20 in the mash step 4, make the method 1 particularly efficient in its use of resources and eliminates the need for processing and/or disposing of these by-products.

Following fermentation 5, the intermediate substrate 14 is treated by applying an oxidizing agent 6 to the substrate, which is now referred to as a ‘moist substrate’ 15. Hydrogen peroxide, which has a strong cytotoxic effect, is used as the oxidizing agent, at a concentration of 40%, whereby the concentration may be adapted according to the specific olfactory-active residues or type of plastic materials. The oxidizing agent 6 works to modify and/or decompose the organic residues, such as fats, proteins, fungi or fungal spores and other organic molecular groups. An optimal moisture content of the moist substrate 15 plays a significant role in the efficiency of the oxidation step 6. For example, a moist substrate 15 that is too dry counteracts a uniform treatment, with the result that extremely intense oxidation can occur locally. On the other hand, a moist substrate 15 that is too wet will inhibit oxidation.

In one embodiment, a conveyor is used to carry the intermediate substrate 14, whereby it is understood that the conveyor has to be constructed of materials that are resistant to the oxidizing agent and any organic acids that may be present in the substrate.

Prior to the step of adding the oxidizing agent 6, the intermediate substrate 14 is deposited onto the conveyor by means of a substrate output device that controls the thickness of the layer of the substrate that is deposited onto the conveyor. In a preferred embodiment, the intermediate substrate 14 is deposited across the width of the conveyor with a layer thickness of at most 50 mm. This thickness ensures that the oxidizing agent 6 penetrates through the entire layer. The moisture content of the intermediate substrate 14 is controlled to facilitate an even distribution of the substrate 14 on the conveyor and to have a viscosity that prevents the substrate from oozing or dripping from the conveyor.

Precisely controllable spray heads are fastened above the conveyor and spray the oxidizing agent 6 onto the intermediate substrate 14 across the entire width of the conveyor. Metering units are provided that allow the spray heads to precisely meter the amount of oxidizing agent 6 that is applied to the substrate 14. Additional spray heads may be provided above the conveyor along the conveying path, to apply additional amounts of the oxidizing agent. The spray heads are individually controllable, so that defined amounts of the oxidizing agent 6 are applied with a high spatial precision. As a result, the amount of the oxidizing agent applied is limited to only what is needed to modify and/or decompose the organic residues and to minimize a degradation of the characteristics of the plastic materials themselves, i.e., the elasto-mechanical properties of the final substrate 17 that is obtained at the conclusion of the method 1.

FIG. 1 illustrates that, in addition to the oxidation step 6, the moist substrate 15 is also subjected to an ultraviolet radiation treatment 7. The UV radiation intensifies the modification and/or the break-down of olfactory-active components. Ultraviolet radiation emitters are arranged above the conveyor in such a way that the moist substrate 15 is irradiated immediately after the addition of the oxidizing agent 6. The area of radiation extends over essentially the entire width of the conveyor and length of the conveying distance. The ultraviolet radiation emitters may be individually controllable, thereby allowing specific regions of the moist substrate 15 located on the conveyor to be irradiated.

A reaction holding time begins as soon as the oxidizing agent 6 is initially added to the moist substrate 15. During this reaction holding time, the moist substrate 15 reacts with the oxidizing agent 6 and, due to exothermic reactions, the process temperature rises to 60 to 80° C. This results in an increase in temperature of the liquid in the moist substrate 15 and a decomposition of thermo-sensitive substances that are contained therein. Additional oxidizing agent 6 may be added during the reaction holding time and the reaction intensified by the ultraviolet radiation treatment 7. Easily volatile organic substances diffuse out of the moist substrate 15 and are removed by a suction device. Less volatile and non-volatile organic fragments remain in the moist substrate 15 and aggregate to some extent with mineral components of the moist substrate 15.

The modification and/or decomposition processes taking place during the reaction holding time have a significant influence on the elasto-mechanical properties of the final substrate 17. Thus, it is necessary to actively monitor and control the reaction holding time and, in particular, to have an automated process monitoring system to monitor of the decomposition of the olfactory-active compounds.

Sensors are provided above the substrate-bearing surface of the conveyor to monitor the moist substrate 15 optically, chemically, and physically during the reaction hold time. Temperature and moisture sensors detect the air temperature and the moisture content of the moist substrate 15. The data thus obtained allows conclusions to be drawn about the chemical reaction that is ongoing. Color sensors detect the appearance of the moist substrate 15. If the moist substrate 15 deviates in certain regions optically from a predetermined specified value, additional hydrogen peroxide 6 may be applied in a targeted manner. Furthermore, the oxidation reaction may be regulated by adjusting the concentration or the amount of the oxidizing agent 6, so that the thus optimized process parameters may be taken into consideration for the subsequent treatment. This also allows the treatment process to be continuously optimized.

The ultraviolet radiation treatment 7 is applied in a targeted manner, to optimize the modification and/or the decomposition of the olfactory-active components in the moist substrate 15. The moist substrate 15 is chemically monitored during the reaction holding time by an in situ analysis of the gas evolution. If, for example, a decreasing VOC content is detected, thereby indicating that the amount of hydrogen peroxide is being used up as decomposition progresses, the radiation intensity may be increased by switching on additional ultraviolet radiation sources.

The feed rate of the conveyor provides a further control variable for adjusting the intensity or duration of the treatment. The aim is that at the end of the reaction holding time, the organic components, in particular the olfactory-active contaminants, are largely modified and/or decomposed, so that no odor-related restrictions stand in the way of subsequent recycling uses. To maintain a preferred duration of the reaction holding time 30 to 35 minutes, the conveyor is driven at a feed rate of 1 m/min.

As shown in FIG. 1, at the end of reaction holding time the treatment steps 6 and 7 are followed by a conditioning step 8 that adjusts the moisture content of the moist substrate 15 to a desired moisture content. At the end of the conditioning 8, the substrate is then referred to as a dry substrate 16. In one embodiment, the conditioning unit is a condensation dryer and the moist substrate 15 is dried to obtain a target moisture content of between 2 and 3% in the dry substrate 16, depending on the intended subsequent recycling use 18 of the final substrate 17. The target moisture is obtained by raising the temperature and/or introducing water or water vapor, as needed. The moist substrate 15 is dried at temperatures between 95 and 175° C. and any olfactory-active components are thermally stressed, thereby promoting a further modification and/or decomposition. Moreover, the elevated process temperatures mobilize organic fragments, so that they diffuse out of the moist substrate 15, thereby contributing to an additional purification of the moist substrate 15.

The dry substrate 16 is then sorted 9 after exiting the conditioning unit 8. Screens with different mesh sizes and air separators with different flow rates separate the individual fragment fractions of the treated plastic materials from one another and make it possible to separate out the mineral components. A final substrate 17 emerges from the sorting process 9. This final substrate 17 has a high degree of purity and is acceptable for recycling in a very wide variety of use options 18.

The final substrate 17 is suitable for use in extrusion or injection molding processes and and may be incorporated into a variety of final substrate uses 18, such as, panel-like material, molded parts, packaging, film, or be used as an additive, for example, as a filler. In principle, the suitability of the final substrate 17 for different the use options 18 is determined by the specified requirements for the elasto-mechanical properties of the final substrate 17. The type of plastic materials, as well as the process control of the method 1, are determinative for these properties. The concentration and/or the amount of the oxidizing agent 6 and the intensity of the ultraviolet radiation 7 are the primary process parameters that need to be individually adapted.

It is understood that the embodiments described herein are merely illustrative of the present invention. Variations in the construction of the method of treating olfactorily contaminated plastic materials and the devices used to implement the method may be contemplated by one skilled in the art without limiting the intended scope of the invention herein disclosed and as defined by the following claims.

What is claimed is:

1: A method of treating plastic materials that are contaminated with olfactory-active residues that adhere to the plastic materials, the method comprising the steps of:
a) pre-treating a raw substrate that is made up of the plastic materials and has a defined fragment size, to obtain an intermediate substrate;
b) treating the intermediate substrate with an oxidizing agent for a period of time that is a reaction holding time, to obtain a moist substrate;
wherein the reaction holding time begins as soon as the oxidizing agent is added to the intermediate substrate;
wherein, during the reaction holding time, the oxidizing agent modifies and/or decomposes the olfactory-active residues, such that the olfactory-active residues are no longer present when the reaction holding time is ended;
wherein an amount and/or a concentration of the oxidizing agent are adjusted to achieve a modification and/or decomposition of the olfactory-active residues in the reaction holding time;
wherein the amount and/or concentration of the oxidizing agent is adjustable to a specific composition of the intermediate substrate; and
wherein the moist substrate substantially retains desired properties of the plastic materials; and
c) conditioning the moist substrate to obtain a dry substrate that has a desired moisture content.

2: The method of claim 1, wherein the step of pre-treating the raw substrate includes a step of:
d) fragmenting the raw substrate.

3: The method of claim 2,
wherein the raw substrate is composed of fragments having a maximum edge length of up to 30 mm.

4: The method of claim 3, wherein the maximum edge length is between 5 and 8 mm.

5: The method of claim 1, wherein the step of pre-treating the raw substrate includes a step of:
a1) providing at least one cleaning step, wherein the cleaning step includes a dry mechanical cleaning, a cold wash, or a hot wash, or any combination thereof.

6: The method of claim 1, wherein the step of pre-treating the raw substrate includes a step of:
a2) fermenting the raw substrate.

7: The method of claim 5,
a3) mixing the raw substrate with water to obtain a mash.

8: The method of claim 6, wherein water obtained from a subsequent method step is added to the mash.

9: The method of claim 6, wherein the step of fermenting includes a step of:
a4) capturing high-energy gases for subsequent use in thermal energy recovery.

10: The method of claim 6, wherein a moisture content of the mash prior to fermentation is between 5 and 15% and the moisture content of the intermediate substrate after fermentation is between 15 and 30%.

11: The method of claim 9, wherein the moisture content prior to fermentation is between 8 and 12%.

12: The method of claim 9, wherein the moisture content on the intermediate substrate is between 15 and 20%.

13: The method of claim 1, wherein hydrogen peroxide is used as the oxidizing agent.

14: The method of claim 13, wherein the hydrogen peroxide has a concentration between 9 and 60%.

15: The method of claim 14, wherein the hydrogen peroxide has a concentration between 35 and 40%.

16: The method of claim 14, wherein the hydrogen peroxide has a concentration of 40%.

17: The method of claim 1, wherein the step of applying an oxidizing agent includes the steps of:
b1) adding a defined amount of the oxidizing agent,
b2) determining the reaction holding time it takes to modify and/or decompose the olfactory-active residues to a pre-specified value,
b3) adjusting the defined amount of the oxidizing agent in order to obtain a specified reaction holding time.

18: The method of claim 17, wherein the specified reaction holding time is between 20 and 40 minutes.

19: The method of claim 18, wherein the specified reaction holding time is between 30 and 35 minutes.

20: The method of claim 1, the step b) including a step of:
b4) subjecting the moist substrate to ultraviolet radiation.

21: The method of claim 1, the step b) including a step of:
b5) monitoring the moist substrate with sensors during the reaction holding time to detect a break-down value of the olfactory-active residues.

22: The method of claim 19, the step b) including a step of:
b6) adapting treatment intensity when an actual break-down value deviates from a specified break-down value.

23: The method of claim 1, wherein step c) includes a step of:
c1) drying the dry substrate as needed to obtain a target moisture of between 0 and 5%.

24: The method of claim 23, wherein the target moisture is between 2 and 3%.
